(19) United States
(12) Patent Application Publication
(10) Pub. No.: US 2010/0309585 A1
(43) Pub. Date: Dec. 9, 2010

(54) HEAD SLIDER AND MAGNETIC DISK DEVICE

(76) Inventors: Masaru FURUKAWA, Fujisawa (JP); Junguo Xu, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/783,896

(22) Filed: May 20, 2010

(30) Foreign Application Priority Data
Jun. 4, 2009 (JP) 2009-135477

(51) Int. Cl. G11B 5/60

(52) U.S. Cl. 360/234.3; G9B/5.229

(57) ABSTRACT

A head slider is capable of restricting deformation of a medium-facing surface, and includes heat generating elements located at a distance from a read/write head in a Y direction corresponding to the radial direction of a disk medium. A width of the heat generating element in a Z direction is smaller than the widths in the X and Y directions.

### BACKGROUND OF THE INVENTION

(i) Field of the Invention

The present invention relates to a head slider and a magnetic disk device, and more particularly, to a head slider with a built-in head positioning mechanism.

(ii) Description of the Related Art

A magnetic disk device uses a head slider including a read/write head. The head slider has an air bearing surface (ABS) provided on the medium-facing surface, and flies close to and above a rotating disk medium. The head slider is moved in the radial direction of the disk medium by a voice coil motor. Such a head slider is disclosed in, for example, JP-A No. 2008-10026.

The present inventors has been contemplated that a heat generating element was mounted in a head slider for displacing a read/write head slightly in at least one of the circumferential and radial directions of a disk medium.

In this case, however, the thermal expansion caused by the heat generating element may possibly deform the medium-facing surface and the deformation may possibly cause variations in flying height of the read/write head. In particular, since the flying height of a read/write head has been greatly reduced in recent years, such deformation of the medium-facing surface may possibly give raise to a collision between the disk medium and the head slider.

### SUMMARY OF THE INVENTION

The present invention has been made in view of the above circumstances and provides a head slider capable of restricting deformation of its medium-facing surface, and a magnetic disk device.

Accordingly, a head slider, which flies over a rotating disk medium, according to an embodiment of the present invention includes: a read/write head that writes and reads data; heat generating elements that are located at a distance from the read/write head in at least one of a first direction corresponding to a circumferential direction of the disk medium and a second direction corresponding to a radial direction of the disk medium; and an expansion member that is interposed at least between the read/write head and the heat generating elements and expands in accordance with a heat generated by the heat generating elements, in which each of the heat generating elements has a width in the first direction, a width in the second direction, and a width in a third direction that corresponds to a flying direction of the head slider and is smaller than the width in the first direction and the width in the second direction.

In one aspect of the present invention, the heat generating element preferably includes a conductor formed in a shape zigzagging in a plane including the first direction and the second direction.

In one aspect of the present invention, the heat generating element is preferably connected to wiring extending in the third direction.

In one aspect of the present invention, preferably, the read/write head preferably includes a recording element writing data and a reproducing element reading data which are arranged in the first direction, and the heat generating element is placed in the second direction of the recording element.

In one aspect of the present invention, preferably, the read/write head includes a recording element writing data and a reproducing element reading data which are arranged in the first direction, and the heat generating element is placed in the second direction of the reproducing element.

In one aspect of the present invention, preferably, the read/write head includes a recording element writing data and a reproducing element reading data which are arranged in the first direction, and the heat generating elements are respectively placed in the second direction of the recording element, and in the second direction of the reproducing element.

In the aspect, a position of the heat generating element in the third direction which is located close to the recording element may be different from a position of the heat generating element in the third direction which is located close to the reproducing element.

In the aspect, a distance between the recording element and the heat generating element close to the recording element may be different from a distance between the reproducing element and the heat generating element close to the reproducing element.

In one aspect of the present invention, preferably, the read/write head includes a recording element writing data and a reproducing element reading data which are arranged in the first direction, and the heat generating element extends in the first direction while including the second direction of the recording element and the second direction of the reproducing element.

In the aspect, a distance between the recording element and a portion of the heat generating element close to the recording element may be different from a distance between the reproducing element and a portion of the heat generating element close to the reproducing element.

In the aspect, the heat generating element may be connected to wiring at a central portion and opposing ends in the first direction.

In one aspect of the present invention, preferably, a medium-facing surface facing the disk medium is made up of a plurality of surfaces that are located at different depths from each other and includes, at least, a stepped bearing surface, a flying pad surface located closer to the disk medium than the stepped bearing surface is located, and a recessed surface located further away from the disk medium than the stepped bearing surface is located, and a position of the heat generating element when it is projected onto the medium-facing surface is included in the surface located further away from the disk medium than the stepped bearing surface is located.

In one aspect of the present invention, preferably, a medium-facing surface facing the disk medium is made up of a plurality of surfaces located at different depths from each other, and a position of the heat generating element when it is projected onto the medium-facing surface is included in the surface which is located at a depth of approximately 150 nm or more with respect to the surface closet to the disk medium.

In one aspect of the present invention, preferably, the head slider further includes a slider substrate and a thin-film lamination member which is made up of a plurality of thin films laminated on an end face of the slider substrate, in which the read/write head and the heat generating elements are formed within the thin-film lamination member.

In the aspect, the heat generating element may be formed by interconnection of conductors respectively formed in the thin films.

A magnetic disk device according to an embodiment of the present invention includes the head slider according to an embodiment of the present invention.

A magnetic disk device according to an embodiment of the present invention includes a head slider that flies over a rotating disk medium, and includes: a read/write head that writes and reads data; heat generating elements that are located at a distance from the read/write head in a direction corresponding to a radial direction of the disk medium; and an expansion member that is interposed at least between the read/write head and the heat generating elements and expands in accordance with a heat generated by the heat generating elements. Each of the heat generating elements has a width in a direction corresponding to a flying direction of the head slider which is smaller than a width in a direction corresponding to a circumferential direction of the disk medium and a width in the direction corresponding to the radial direction of the disk medium. The magnetic disk device further includes a control circuit that passes electric current through the heat generating elements in accordance with an error of a position of the read/write head with respect to a track formed in the disk medium.

According to present invention, among expansions produced around the heat generating elements, the expansions in the first direction and the second direction are relatively great, and the expansion in the third direction is relatively small, thus making it possible to restrict deformation of the medium-facing surface of the head slider.

### BRIEF DESCRIPTION OF THE DRAWINGS

Embodiments of the present invention will be described in detail with reference to the following drawings, wherein:

FIG. 1 is a plan view of a magnetic disk device according to one embodiment of the present invention;

FIG. 2 is a bottom view of a head slider according to one embodiment of the present invention;

FIG. 3A is an enlarged view of a main part of the head slider;

FIG. 3B is an enlarged view of a main part of the head slider;

FIG. 4A is a diagram illustrating a heat generating element included in the head slider;

FIG. 4B is a diagram illustrating a heat generating element included in the head slider;

FIG. 5A is a diagram illustrating a heat generating element included in the head slider;

FIG. 5B is a diagram illustrating a heat generating element included in the head slider;

FIG. 6 is a diagram showing an exemplary head slider according to a modification of the present invention;

FIG. 7 is a diagram showing an exemplary head slider according to a modification of the present invention;

FIG. 8 is a diagram showing an exemplary head slider according to a modification of the present invention;

FIG. 9A is a diagram showing an exemplary head slider according to a modification of the present invention;

FIG. 9B is a diagram showing an exemplary head slider according to a modification of the present invention;

FIG. 10 is a diagram showing an exemplary head slider according to a modification of the present invention;

FIG. 11 is a diagram showing an exemplary head slider according to a modification of the present invention; and

FIG. 12 is a diagram showing an exemplary head slider according to a modification of the present invention.

### DETAILED DESCRIPTION OF THE INVENTION

A head slider and a magnetic disk device according to an embodiment of the present invention will be described below with reference to the accompanying drawings.

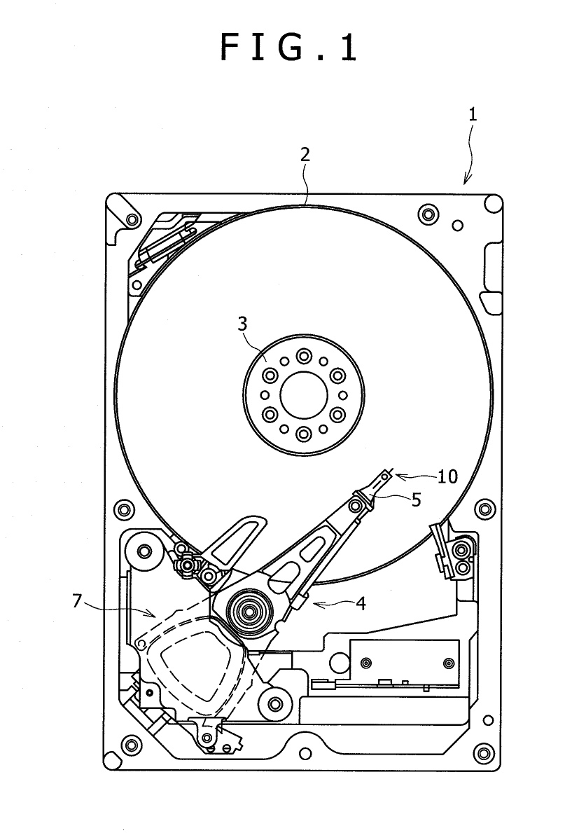

FIG. 1 is a plan view of a magnetic disk device 1, which omits illustration of the top cover. The magnetic disk device 1 has a housing which contains a magnetic disk medium 2 and a head assembly 4. The magnetic disk medium 2 is mounted on a spindle motor 3 which is provided on the bottom of the housing. The head assembly 4 is located next to the magnetic disk medium 2 and pivotally supported. A suspension arm 5 is mounted at a leading end of the head assembly 4. A head slider 10 is supported at a leading end of the suspension arm 5. On the other hand, a voice coil motor 7 is provided at a trailing end of the head assembly 4. A board including a control circuit (not shown) is provided outside the housing of the magnetic disk device 1.

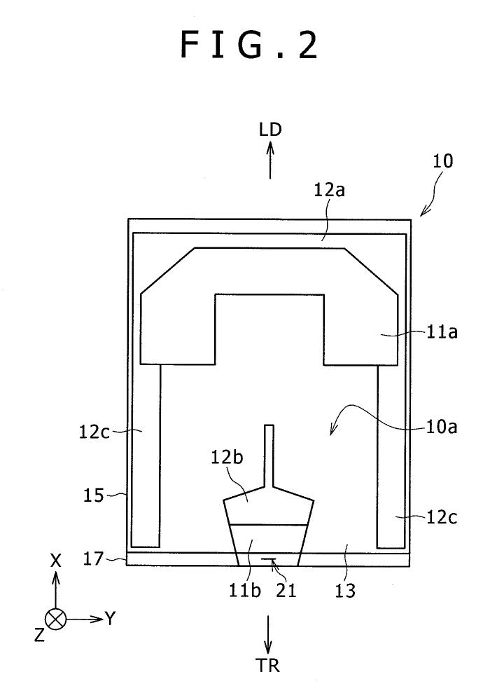

FIG. 2 is a bottom view of the head slider 10. The X direction (first direction) refers to the length direction of the head slider 10, which corresponds to a circumferential direction of the magnetic disk medium 2. The Y direction (second direction) refers to the width direction of the head slider 10, which corresponds to a radial direction of the magnetic disk medium 2. The Z direction (third direction) refers to the thickness direction of the head slider 10, which corresponds to the flying direction of the head slider 10. Arrows LD and TR in FIG. 2 indicate the leading direction and the trailing direction of the head slider 10, respectively.

The head slider 10 is formed in, for example, an approximately rectangular parallelepiped shape with a length of about 1.25 mm, a width of about 1.0 mm and a thickness of about 0.3 mm (which is a size called “a pico slider”). Alternatively, the head slider 10 may be formed in, for example, an approximately rectangular parallelepiped shape with a length of about 0.85 mm, a width of about 0.7 mm and a thickness of about 0.23 mm (which is a size called “a femto slider”), or may be formed in another size.

The head slider 10 has a medium-facing surface 10a facing the magnetic disk medium 2. An air bearing surface (hereinafter referred to as “ABS”) is formed on the medium-facing surface 10a. The head slider 10 receives an air flow produced by the rotation of the magnetic disk medium 2 so as to fly over and close to the magnetic disk medium 2. The medium-facing surface 10a is made up of plural surfaces which are virtually parallel to each other and differ in depth (or level) from each other. The configuration of such a medium-facing surface 10a is formed by use of, for example, ion milling, etching or the like.

Specifically, the medium-facing surface 10a mainly includes flying pad surfaces 11a, 11b which are located closet to the magnetic disk medium 2, stepped bearing surfaces 12a, 12b, 12c which are at a level deeper than the level of the flying pad surfaces 11a, 11b, and a recessed surface 13 which is at a level deeper than the level of the stepped bearing surfaces 12a to 12c. For example, with respect to the flying pad surfaces 11a, 11b, the stepped bearing surfaces 12a to 12c is located at a depth ranging from about 100 nm or more to about 300 nm or less, and the recessed surface 13 is located at a depth of about 1 μm or more. The configuration of the medium-facing surface 10a is not limited to the form illustrated in FIG. 2 and an arbitrary ABS can be suitably employed.

When an air flow produced by the rotation of the magnetic disk medium 2 travels from the stepped bearing surfaces 12a to 12c and/or the recessed surface 13 onto the flying pad surfaces 11a, 11b, the air flow is compressed because of the tapered flow path, thus developing a positive pressure (gas pressure acting in the direction in which the head slider moves away from the magnetic disk medium 2). On the other hand, when an air flow produced by the rotation of the magnetic disk medium 2 travels from the flying pad surfaces 11a, 11b and/or the stepped bearing surfaces 12a to 12c onto the recessed surface 13, the cross-sectional area of the flow path is gradually increased, thus developing a negative pressure (gas pressure acting in the direction in which the head slider moves toward the magnetic disk medium 2).

An end face of a read/write head 21, described later, is exposed on the trailing end of the flying pad surface 11b. The end face may be located above, may be flush with, or alternatively may be located below the flying pad surface 11b. In addition, an intermediate surface may be provided at the trailing end of the recessed surface 13 and located at an intermediate depth between the stepped bearing surfaces 12a to 12c and the recessed surface 13. In this case, a depth of about 150 nm or more, for example, is set for the intermediate surface.

The head slider 10 has a slider substrate 15 which is made of a sintered material containing alumina and titanium carbide (so-called AlTic), and a thin-film lamination member 17 which is formed on the face of the trailing end of the slider substrate 15. The thin-film lamination member 17 is formed of laminated thin films made of alumina. The alumina-made thin films serve as an expansion member which expands in accordance with a heat applied thereto.

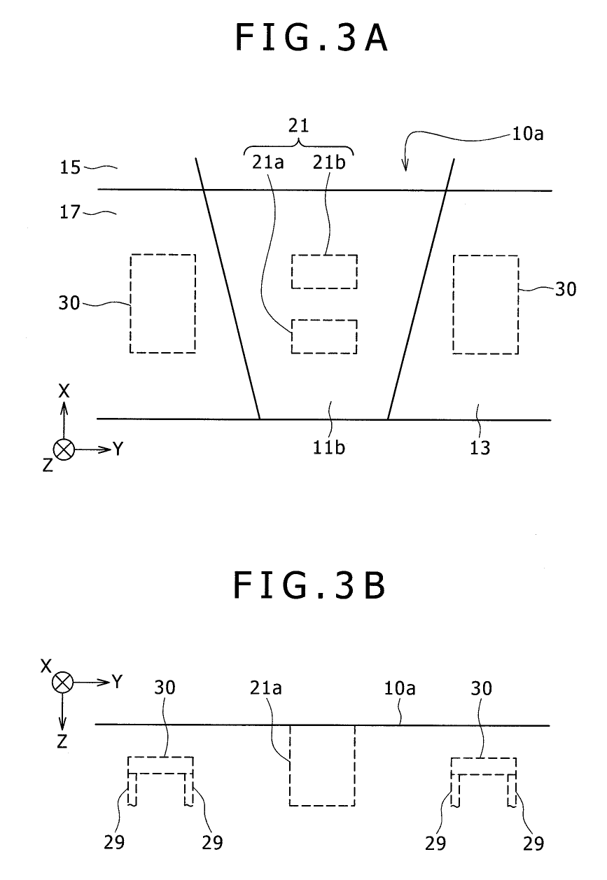

The read/write head 21 is formed in the thin-film lamination member 17. As shown in FIG. 3A, the read/write head 21 includes a recording element 21a disposed in a portion closer to the trailing side, and a reproducing element 21b formed in a portion closer to the leading side. The recording element 21a includes an inductive element and writes data on the magnetic disk medium 2. The reproducing element 21b includes a magnetoresistance effect element and reads data from the magnetic disk medium 2.

As shown in FIG. 3A and FIG. 3B, heat generating elements 30 are formed in the thin-film lamination member 17. The heat generating elements 30 are placed on opposite sides of the recording element 21a and the reproducing element 21b in the Y direction and in positions at a distance from them. The heat generating elements 30 are each formed in a flat shape extending in the XY plane and located at a predetermined distance from the medium-facing surface 10a. The heat generating elements 30 extend in the X direction in such a manner as to surround an area in both the Y direction of the recording element 21a and the Y direction of the reproducing element 21b. In addition, each of the heat generating elements 30 is connected to wiring 29 extending in the Z direction and generates heat when energized by the control circuit (not shown). The amount of heat generated by the heat generating element 30 and the wiring 29 is varied depending on shapes, materials and/or the like of the heat generating element 30 and the wiring 29. Though not shown in FIG. 3A and FIG. 3B, it goes without saying that the wiring 29 may be mounted in the X direction or in the Y direction in accordance with a shape or materials of the heat generating element 30 and the wiring 29 or a method of mounting the head slider.

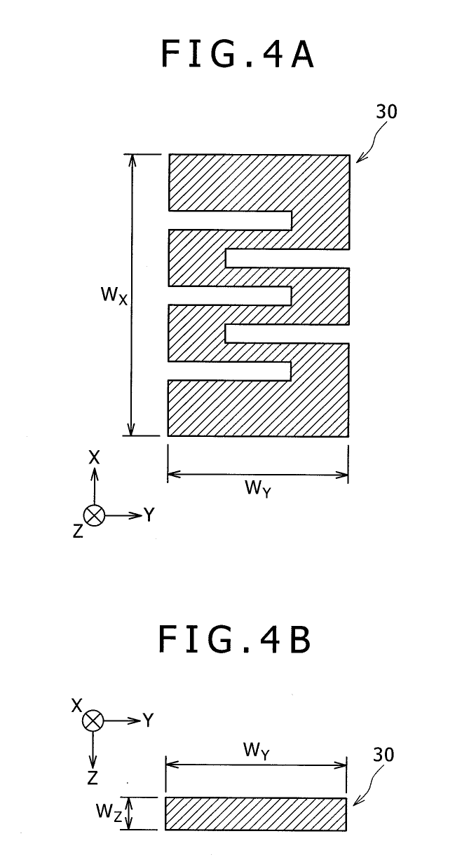

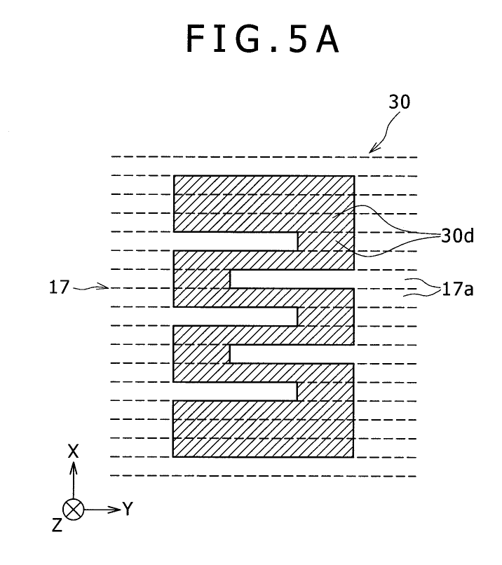

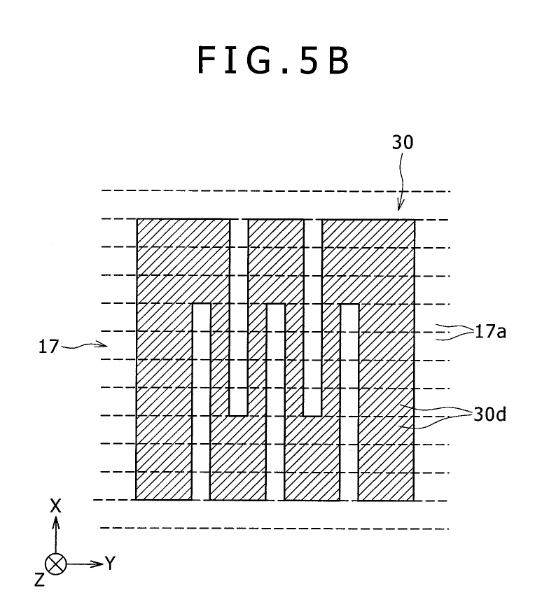

Specifically, as shown in FIG. 4A and FIG. 4B, the heat generating element 30 includes a conductor formed in a meandering shape in the XY plane. Nickel chrome (NiCr), copper (Cu), tungsten (W) and/or the like can be used for the conductor forming part of the heat generating element 30. Here, the Z-direction width W_{Z} of the heat generating element 30 is smaller than the X-direction width W_{X} and the Y-direction width W_{Y} of the same. The width in each of the directions is defined as a length extending along the direction from one outermost end to the other outermost end in the direction. As shown in FIG. 5A and FIG. 5B, the heat generating element 30 is formed by interconnecting conductors 30d which are respectively formed in thin films 17a which makes up the thin-film lamination member 17.

The conductor used herein for forming part of the heat generating element 30 is not limited to the foregoing examples, and any material can be preferably used as long as it exhibits a volume resisivity of 100×10⁻⁸ (Ω·m) or less at a temperature of 100° C.

As shown in FIG. 3A, the heat generating element 30 is positioned such that, when the heat generating element 30 is projected onto the medium-facing surface 10a in the Z direction, its projected position is included in the recessed surface 13 which is deeper than the stepped bearing surfaces 12a to 12c. The projected position is not so limited, and it may be included in another surface as long as the surface is located at a depth of about 150 nm or more with respect to the flying pad surface 11b.

The heat generating element 30 generates heat which causes expansions around the heat generating element 30. Among them, an expansion of an intermediate area between the heat generating element 30 and the read/write head 21 induces a displacement of the read/write head 21 in the Y direction. Specifically, heat is generated by one of the heat generating elements 30 situated respectively on opposite sides of the read/write head 21 in the Y direction. This heat causes an expansion in the intermediate area between the heat generating element 30 generating heat and the read/write head 21, thereby displacing the read/write head 21 toward the other heat generating element 30.

In this manner, the heat generating element 30 functions as a heat actuator for displacing the read/write head 21 in the Y direction. Since the Y direction corresponds to the radial direction of the magnetic disk medium 2, that is, the width direction of a track, such displacement of the read/write head 21 in the Y direction can be applied to the positioning control for positioning of the read/write head 21 to a track. Specifically, the control circuit (not shown) mounted in the magnetic disk device 1 calculates an error of the position of the read/write head 21 with respect to a target track on the basis of servo data read from the magnetic disk medium 2 by the read/write head 21, and then selectively applies electric current to the heat generating element 30 to reduce the positional error.

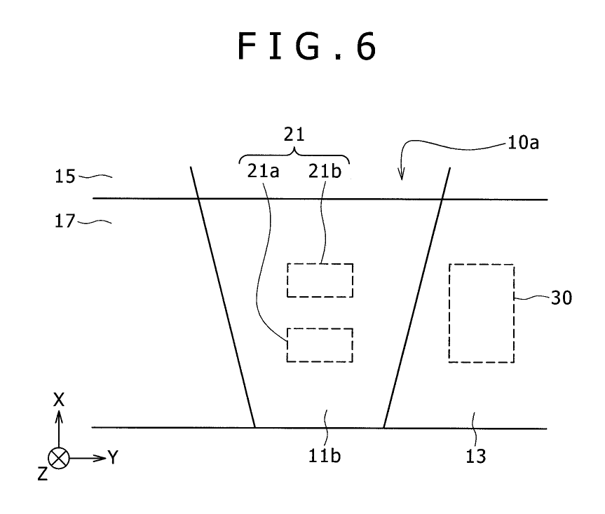

As shown in FIG. 6, the heat generating element 30 may be provided on one side of the read/write head 21 in the Y direction. In this case, when the amount of heat generated by the heat generating element 30 exceeds a predetermined amount, an expansion occurs in the intermediate area between the heat generating element 30 and the read/write element 21, thus inducing a displacement of the read/write head 21 in the direction away from the heat generating element 30.

The heat generating element 30 and the read/write head 21 may be placed such that, when the amount of heat generated by the heat generating element 30 is equal to the predetermined amount, the read/write head 21 is located around the center of the thin-film lamination member 17 in the Y direction. In this event, when the amount of heat generated by the heat generating element 30 decreases to below the predetermined amount, a contraction causes in the intermediate area between the heat generating element 30 and the read/write head 21, thus inducing a displacement of the read/write head 21 toward the heat generating element 30.

According to the foregoing embodiment, as illustrated in FIGS. 3A to 4B, the heat generating element 30 is shaped in a flat form extending in the XY plane, and the Z-direction width W_{Z} is smaller than the X-direction width W_{X} and the Y-direction width W_{Y}. For this reason, among other expansions caused around the heat generating element 30, the expansions in the X direction and the Y direction are relatively high, thus inhibiting displacement of the read/write head 21. On the other hand, the expansion in the Z direction is relatively low, thus inhibiting deformation of the medium-facing surface 10a.

As shown in FIG. 3A, the heat generating element 30 extends in the X direction such that an area close to the recording element 21a in the Y direction and an area close to the reproducing element 21b in the Y direction are included. As a result, the recording element 21a and the reproducing element 21b are both displaced in the Y direction.

As shown in FIG. 3B, the heat generating element 30 is located away from the medium-facing surface 10a in the Z direction, and is not exposed to the outside. For this reason, the heat escaping from the medium-facing surface 10a to the outside is reduced to improve the expansions in the X direction and the Y direction.

As shown in FIG. 3A, the projected position of the heat generating element 30 when it is projected onto the medium-facing surface 10a is included in the recessed surface 13. This is preferable because the recessed surface 13, even when deformed, has little effect on the flying of the head slider 10.

As shown in FIG. 5A and FIG. 5B, the heat generating element 30 may be formed in a zigzag shape extending back and forth either in the Y direction or in the X direction. In the case of the zigzag shape in the X direction, it is possible to freely set a width of each linear conductor.

Modifications according to the embodiment described above will be described below. The same components repeatedly described in the modifications as those in the embodiment are designated the same reference numerals in the drawing and details are omitted.

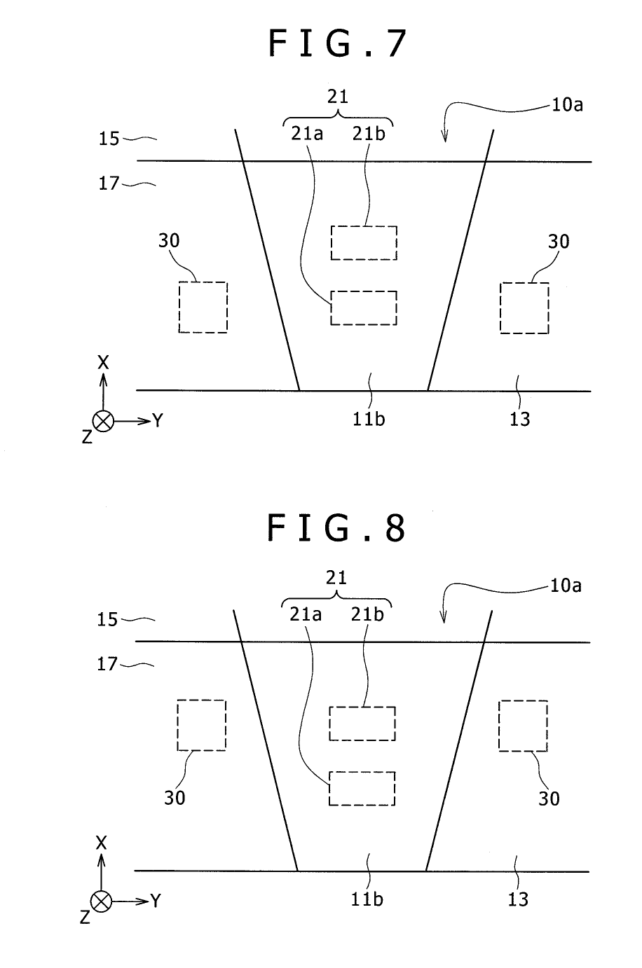

As illustrated in FIG. 7, the heat generating elements 30 may be arranged on opposite sides of the recording element 21a in the Y direction and may not be placed on opposite sides of the reproducing element 21b in the Y direction. As a result, the displacement of the recording element 21a in the Y direction is increased as compared with the displacement of the reproducing element 21b in the Y direction. Also, the amount of heat transferred to the reproducing element 21b is less than the amount of heat transferred to the recording element 21a. Specially, since the reproducing element 21b including a magnetoresistance effect element easily deteriorates in performance due to heat, this example is preferable.

As shown in FIG. 8, the heat generating elements 30 may be arranged on opposite sides of the reproducing element 21b in the Y direction and may not be placed on opposite sides of the recording element 21a in the Y direction. As a result, the displacement of the reproducing element 21b in the Y direction is increased as compared with the displacement of the recording element 21a in the Y direction. Also, the amount of heat transferred to the recording element 21a is less than the amount of heat transferred to the reproducing element 21b.

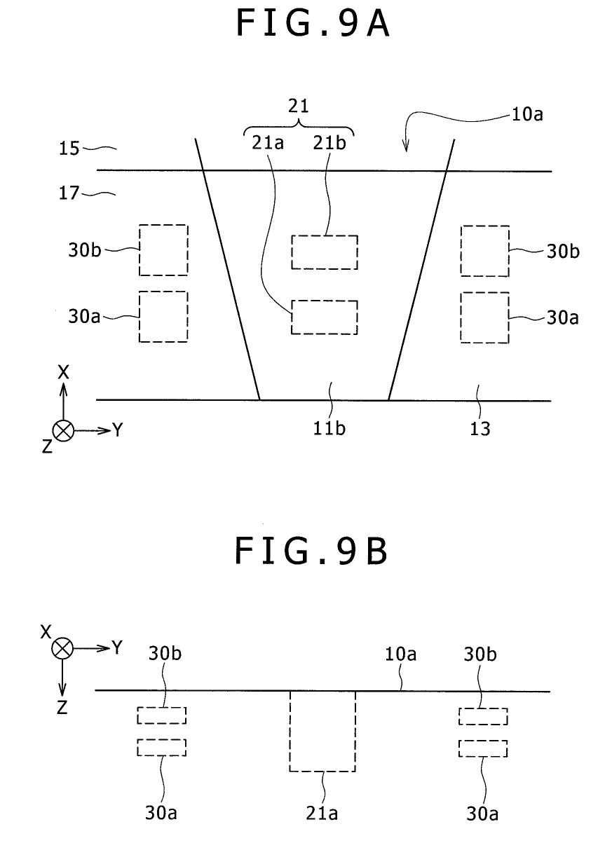

As illustrated in FIG. 9A, recording-element heat generating elements 30a and reproducing-element heat generating elements 30b may be respectively placed on opposing sides of the recording element 21a in the Y direction and on opposing sides of the reproducing element 21b in the Y direction. With this design, the recoding element 21a and the reproducing element 21b can be individually deformed in the Y direction.

As illustrated in FIG. 9B, the position of the recording-element heat generating element 30a in the Z direction may be different from the position of the reproducing-element heat generating element 30b in the Z direction. With this design, it is possible to position the recording-element heat generating element 30a and the reproducing-element heat generating element 30b at respective suitable levels. For example, since in general the reproducing element 21b has a Z-direction length shorter than that of the recording element 21a, it is preferable that the reproducing-element heat generating element 30b is positioned closer to the medium-facing surface 10a than the recording-element heat generating element 30a is positioned, as shown in FIG. 9B.

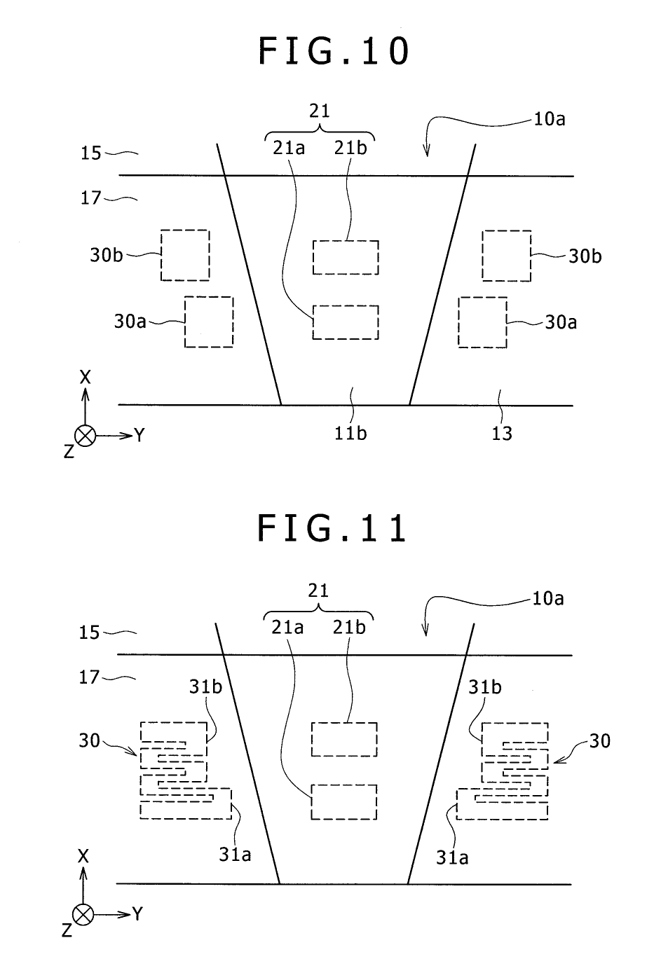

As illustrated in FIG. 10, the distance between the recording-element heat generating element 30a and the recording element 21a may be different from the distance between the reproducing-element heat generating element 30b and the reproducing element 21b. With this design, it is possible to position the recording-element heat generating element 30a and the reproducing-element heat generating element 30b at respective suitable distances from the recording element 21a and the reproducing element 21b. For example, the recording-element heat generating element 30a may be placed closer to the recording element 21a which has a relatively high resistance to heat in order to increase the displacement in the Y direction.

As illustrated in FIG. 11, the heat generating element 30 may be deformed to cause a difference between the distance from a recording-element heat generator 31a to the recording element 21a and the distance from a reproducing-element heat generator 31b to the reproducing element 21b. With this design, it is possible to place the recording-element heat generator 31a and the reproducing-element heat generator 31b at appropriate distances from the recording element 21a and the reproducing element 21b, respectively. For example, the recording-element heat generator 30a may be placed closer to the recording element 21a which has a relatively high resistance to heat in order to increase the displacement in the Y direction.

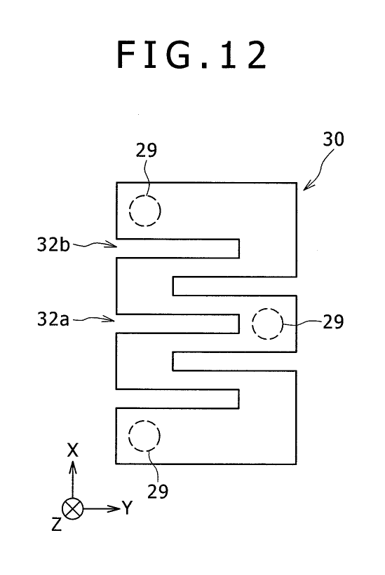

As illustrated in FIG. 12, the heat generating element 30 may be connected to wiring 29 at its two ends and its central portion in the X direction. With this design, since the recording-element heat generator 32a and the reproducing-element heat generator 32b can be operated to generate heat independently of each other in a single heat generating element 30, this makes it possible to individually displace the recording element 21a and the reproducing element 21b in the Y direction.

An exemplary embodiment of the invention has been described above, but it will be understood that the present invention is not limited to the embodiment and various modifications may be made by those skilled in the art.

In the embodiment, the heat generating element 30 is located at a distance from the read/write head 21 in the Y direction, which not so limited. The heat generating element 30 may be placed at a distance from the read/write head 21 in the X direction. With this placement, it is possible to displace the read/write head 21 in the X direction corresponding to the circumferential direction of the magnetic disk medium 2. This technique is useful for bit patterned media in which arrays of magnetic bits magnetically separated are patterned to form tracks.

In the forgoing embodiment, the read/write head 21 includes the recording element 21a situated on the trailing side and the reproducing element 21b situated on the leading side. However, the read/write head 21 may include a reproducing element 21b placed on the trailing side and a recording element 21a placed on the leading side. The read/write head 21 may include either the recording element 21a or the reproducing element 21b.

It should be understood by those skilled in the art that various modifications, combinations, sub-combinations and alternations may occur depending on design requirements and other factors insofar as they are within the scope of the appended claims or the equivalents thereof.

What is claimed is:

1. A head slider which flies over a rotating disk medium, comprising:
a read/write head that writes and reads data;
heat generating elements that are located at a distance from the read/write head in at least one of a first direction corresponding to a circumferential direction of the disk medium and a second direction corresponding to a radial direction of the disk medium; and
an expansion member that is interposed at least between the read/write head and the heat generating elements and expands in accordance with a heat generated by the heat generating elements,
wherein each of the heat generating elements has a width in the first direction, a width in the second direction, and a width in a third direction corresponding to a flying direction of the head slider, the width in the third direction being smaller than the width in the first direction and the width in the second direction.

2. The head slider according to claim 1, wherein the heat generating element includes a conductor formed in a shape zigzagging in a plane including the first direction and the second direction.

3. The head slider according to claim 1, wherein the heat generating element is connected to wiring extending in the third direction.

4. The head slider according to claim 1, wherein
the read/write head includes a recording element which writes data, and a reproducing element which reads data, the recording element and the reproducing element being arranged in the first direction, and
the heat generating element is placed in the second direction of the recording element.

5. The head slider according to claim 1, wherein
the read/write head includes a recording element which writes data, and a reproducing element which reads data, the recording element and the reproducing element being arranged in the first direction, and
the heat generating element is placed in the second direction of the reproducing element.

6. The head slider according to claim 1, wherein
the read/write head includes a recording element which writs data, and a reproducing element which reads data, the recording element and the reproducing element being arranged in the first direction, and
the heat generating elements are respectively placed in the second direction of the recording element, and in the second direction of the reproducing element.

7. The head slider according to claim 6, wherein a position of the heat generating element in the third direction which is located close to the recording element is different from a position of the heat generating element in the third direction which is located close to the reproducing element.

8. The head slider according to claim 6, wherein a distance between the recording element and the heat generating element located close to the recording element is different from a distance between the reproducing element and the heat generating element located close to the reproducing element.

9. The head slider according to claim 1, wherein
the read/write head includes a recording element which writs data, and a reproducing element which reads data, the recording element and the reproducing element being arranged in the first direction, and
the heat generating element extends in the first direction while including the second direction of the recording element and the second direction of the reproducing element.

10. The head slider according to claim 9, wherein a distance between the recording element and a portion of the heat generating element close to the recording element is different from a distance between the reproducing element and a portion of the heat generating element close to the reproducing element.

11. The head slider according to claim 9, wherein the heat generating element is connected to wiring at a central portion and opposing ends in the first direction.

12. The head slider according to claim 1,
wherein a medium-facing surface facing the disk medium is made up of a plurality of surfaces located at different depths from each other, the plurality of surfaces including: at least,
a stepped bearing surface;
a flying pad surface located closer to the disk medium than the stepped bearing surface is located; and
a recessed surface located further away from the disk medium than the stepped bearing surface is located, and
wherein a position of the heat generating element when the heat generating element is projected onto the medium-facing surface is included in the surface located further away from the disk medium than the stepped bearing surface is located.

13. The head slider according to claim 1,
wherein a medium-facing surface facing the disk medium is made up of a plurality of surfaces located at different depths from each other, and
wherein a position of the heat generating element when the heat generating element is projected onto the medium-facing surface is included in the surface which is located at a depth of approximately 150 nm or more with respect to the surface closet to the disk medium.

14. The head slider according to claim 1, further comprising:
a slider substrate; and
a thin-film lamination member made up of a plurality of thin films laminated on an end face of the slider substrate,
wherein the read/write head and the heat generating elements are formed within the thin-film lamination member.

15. The head slider according to claim 14, wherein the heat generating element is formed by interconnection of conductors respectively formed in the thin films.

16. A magnetic disk device, comprising the head slider according to claim 1.

17. A magnetic disk device, comprising:
a head slider that flies over a rotating disk medium, and includes a read/write head that writes and reads data, heat generating elements that are located at a distance from the read/write head in a direction corresponding to a radial direction of the disk medium, and an expansion member that is interposed at least between the read/write head and the heat generating elements and expands in accordance with a heat generated by the heat generating elements, each of the heat generating elements having a width in a direction corresponding to a flying direction of the head slider which is smaller than a width in a direction corresponding to a circumferential direction of the disk medium and a width in the direction corresponding to the radial direction of the disk medium; and
a control circuit that passes electric current through the heat generating element in accordance with an error of a position of the read/write head with respect to a track formed in the disk medium.
